(19) United States
(12) Patent Application Publication
(10) Pub. No.: US 2025/0157154 A1
(43) Pub. Date: May 15, 2025

(54) METHOD AND APPARATUS OF PATTERNS FOR CLOTHING SIMULATION USING NEURAL NETWORK MODEL

(71) Applicant: CLO Virtual Fashion Inc., Seoul (KR)

(72) Inventors: Dong Sig KANG, Seoul (KR); Eun Jung JU, Seoul (KR)

(21) Appl. No.: 19/020,237

(22) Filed: Jan. 14, 2025

Related U.S. Application Data
(63) Continuation of application No. PCT/KR2024/096052, filed on Aug. 20, 2024.

(30) Foreign Application Priority Data
Aug. 22, 2023 (KR) 10-2023-0110167
Mar. 20, 2024 (KR) 10-2024-0038705
May 17, 2024 (KR) 10-2024-0064862

(51) Int. Cl. G06T 19/00

(52) U.S. Cl. CPC G06T 19/00; G06T 2210/16

(57) ABSTRACT

A clothing simulation method and apparatus are provided. The clothing simulation method includes obtaining pattern information for each of patterns of a garment, the pattern information including information about sample points extracted from each of the patterns, based on an embedding vector for each of the patterns obtained by applying the pattern information to a pattern embedding model trained to estimate a correlation between input pattern information, predicting sewing information about the patterns, and based on the sewing information, generating a simulation result of the garment.

### CROSS-REFERENCE TO RELATED APPLICATIONS

This is a bypass continuation of International PCT Application No. PCT/KR2024/096052, filed on Aug. 20, 2024, which claims priority to Republic of Korea Patent Application No. 10-2023-0110167, filed on Aug. 22, 2023, Republic of Korea Patent Application No. 10-2024-0038705, filed on Mar. 20, 2024, and Republic of Korea Patent Application No. 10-2024-0064862, filed on May 17, 2024, the entire disclosures of which are incorporated herein by reference for all purposes.

### BACKGROUND

### 1. Field

Embodiments described herein relate to automatically placing patterns of clothing on a three-dimensional (3D) avatar for simulation.

### 2. Description of the Related Art

A garment appears three-dimensional (3D) when worn by a person, but the garment is more of a two-dimensional (2D) object because it is a combination of pieces of fabric that are cut according to a 2D pattern. Because fabric, that is, a material of a garment, is flexible, the shape of the fabric may vary depending on the body shape or movement of a person wearing the garment. In addition, different fabrics may have different physical properties (e.g., strength, elasticity, and shrinkage). Because of such differences, garments made of the same shaped patterns express different behavior, look and feel when donned on a 3D avatar.

In the garment industry, computer-based clothing simulation technology is widely used to develop actual clothing designs. During clothing simulation, a user typically manually arranges clothing patterns of a garment at suitable positions on a three-dimensional (3D) avatar. Such arrangement of patterns may involve a great amount of time and impose difficulty on a user with a lack of expertise in clothing designing or simulation.

### SUMMARY

Embodiments relate to arrangement patterns of a garment for performing simulation on a computing device by using a neural network model. Pattern information indicating configurations of each of the patterns is received. The pattern information is applied to a neural network model to extract features from the configurations of each of the patterns. Arrangement points for placing the patterns relative to a three-dimensional (3D) avatar on which the garment is placed by processing the extracted features are predicted. At least a subset of the patterns is arranged at the predicted arrangement points. The patterns from the arrangement points are assembled into the garment placed on the 3D avatar. Simulation of the garment is performed on the 3D avatar. Embodiments may provide technology of improving accuracy of a model by training the model that outputs an embedding vector for each pattern from pattern information for each pattern using both a loss about arrangement information of patterns and a loss about sewing information of the patterns. However, the technical aspects are not limited to the aforementioned aspects, and other technical aspects may be present.

In one or more embodiments, there is provided a clothing simulation method including obtaining pattern information for each of patterns of a garment, the pattern information including information about sample points extracted from each of the patterns, based on an embedding vector for each of the patterns obtained by applying the pattern information to a pattern embedding model trained to estimate a correlation between input pattern information, predicting sewing information about the patterns, and based on the sewing information, generating a simulation result of the garment.

In one or more embodiments, the clothing simulation method may further include extracting a predetermined number of sample points from each of the patterns of the garment and based on a position of a predetermined type of a point included in each of the patterns, adjusting positions of the sample points.

In one or more embodiments, the obtaining of the pattern information for each of the patterns may include obtaining information about sample points of a target pattern, based on a length of an outline from a reference point of the target pattern among the patterns of the garment to each sample point extracted from the target pattern.

In one or more embodiments, the pattern embedding model may include a transformer encoder, and the predicting of the sewing information may include obtaining information indicating a sewing line of a pattern pair extracted from the patterns by applying, to a transformer decoder, an embedding vector pair corresponding to the pattern pair.

In one or more embodiments, the pattern embedding model may include a first transformer encoder trained to estimate a correlation between sample points extracted from a same pattern from input pattern information and a second transformer encoder trained to estimate a correlation between patterns from encoding data for each of the patterns obtained from embedding vectors of sample points output from the first transformer encoder.

In one or more embodiments, the predicting of the sewing information may include obtaining encoding data of a first pattern including an embedding vector for each sample point corresponding to the first pattern by applying pattern information of the first pattern to the first transformer encoder, obtaining encoding data of a second pattern including an embedding vector for each sample point corresponding to the second pattern by applying pattern information of the second pattern to the first transformer encoder, obtaining an embedding vector of the first pattern and an embedding vector of the second pattern by applying the encoding data of the first pattern and the encoding data of the second pattern to the second transformer encoder, and predicting sewing information about a pattern pair of the first pattern and the second pattern by applying the embedding vector of the first pattern and the embedding vector of the second pattern to a transformer decoder.

In one or more embodiments, the sewing information may include a pair of lines sewn together within the patterns.

In one or more embodiments, the sewing information may further include information indicating a sewing direction of the lines.

In one or more embodiments, the information indicating the sewing line of the pattern pair may include information about sample points that are extracted from a first pattern of the pattern pair and correspond to a starting point and an end point of the sewing line included in the first pattern and information about sample points that are extracted from a second pattern of the pattern pair and correspond to a starting point and an end point of the sewing line included in the second pattern.

In one or more embodiments, the pattern embedding model may be trained based on a loss about a difference between the predicted sewing information and ground truth.

In one or more embodiments, the predicting of the sewing information about the patterns may include predicting arrangement information about the patterns and the sewing information, based on an embedding vector for each of the patterns, and the generating of the simulation result of the garment may include generating the simulation result of the garment, based on the sewing information and the arrangement information.

In one or more embodiments, the pattern embedding model may be trained based on a loss about a difference between the predicted sewing information and ground truth and a loss about a difference between the predicted arrangement information and ground truth.

In one or more embodiments, the information about the sample points may include at least one of information indicating positions of the sample points within a pattern, information indicating positions of the sample points within the garment, information indicating a positional relationship between sample points adjacent to each other, and information indicating a type of the sample points.

In one or more embodiments, there is provided a clothing simulation apparatus including a processor configured to obtain pattern information for each of patterns of a garment, the pattern information including information about sample points extracted from each of the patterns, based on an embedding vector for each of the patterns obtained by applying the pattern information to a pattern embedding model trained to estimate a correlation between input pattern information, predict sewing information about the patterns, and based on the sewing information, generate a simulation result of the garment.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a flowchart of automatically arranging patterns of a garment on a 3D avatar, according to an embodiment.

FIG. 2 is a diagram illustrating sample points of a pattern and information indicating positions of the sample points within the pattern, according to an embodiment.

FIG. 3 is a diagram illustrating sample point information, according to an embodiment.

FIGS. 4A and 4B are diagrams illustrating sewing information and automatically matched sewing parts, according to an embodiment.

FIG. 5 is a block diagram illustrating a structure of a n neural network model for a clothing simulation of predicting sewing information, according to an embodiment.

FIG. 6 is a block diagram illustrating a structure of a neural network model for predicting sewing information and arrangement information, according to an embodiment.

FIG. 7 is a diagram illustrating arrangement points and associated arrangement plates, according to an embodiment.

FIG. 8 is a block diagram illustrating an automatic arrangement device, according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

With regard to the description of the drawings, similar reference numerals may be used to refer to similar or related components. It is to be understood that a singular form of a noun corresponding to an item may include one or more of the things, unless the relevant context clearly indicates otherwise.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof.

Terms such as “1st” and “2nd,” or “first” and “second” may be used to simply distinguish a corresponding component from other components, and do not limit the components in other aspects (e.g., importance or order). For example, a first component may be referred to as a second component, and similarly the second component may also be referred to as the first component.

It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., wiredly), wirelessly, or via a third component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like components and a repeated description related thereto will be omitted to avoid obfuscation of the embodiments.

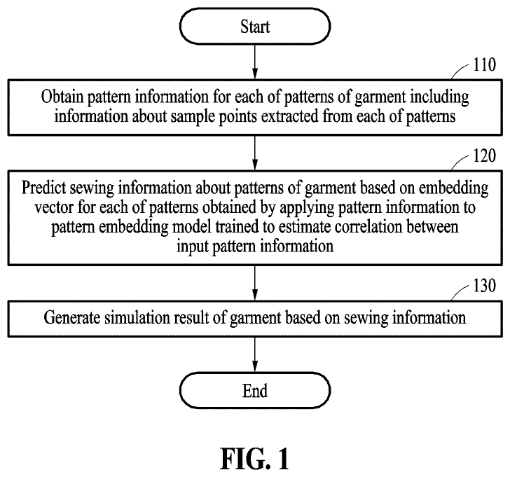

FIG. 1 is a flowchart of automatically arranging patterns of a garment on a 3D avatar, according to an embodiment.

Referring to FIG. 1, the automatic arrangement device may obtain 110 pattern information for each of patterns of a garment. The pattern information may include information about sample points extracted from each of patterns.

A pattern described herein refers to a design or configuration of a two-dimensional (2D) fabric generated and processed by a computer program. The pattern may be part of a garment for placement on a 3D avatar. The term “pattern” and the term “clothing pattern” are used interchangeably herein.

A pattern may be modeled as a combination of meshes. A mesh may be triangular where each of the three vertices of the mesh is assigned with mass (e.g., point mass), and sides of the mesh are represented by elastic springs that connect the masses. Such pattern may be modeled by, for example, a mass-spring model where each of the springs have respective resistance values with respect to, for example, stretching, shearing, and bending, according to the physical properties of the fabric used. Each vertex may move according to an external force such as gravity and an internal force due to stretching, shearing, and bending. By calculating the external force and the internal force to obtain a force applied to each vertex, a displacement and speed of a movement of each vertex may be determined. In addition, using the collective movement of vertices of the meshes at each time step, the temporal and spatial movement of a virtual garment including the meshes may be simulated. Draping 2D virtual clothing patterns formed with triangular meshes on a 3D avatar may implement a natural-looking 3D virtual garment based on the laws of physics. In other embodiments, the meshes may have shapes other than triangles (e.g., quadrilateral shapes).

There may be a plurality of patterns for making a garment. Each pattern of the garment may refer to each of the plurality of patterns for making the garment. Pattern information for each pattern obtained in 110 may include pattern information for each of the patterns of the garment. For example, when a pattern of the garment includes a first pattern and a second pattern, the pattern information for each pattern may include pattern information of the first pattern and pattern information of the second pattern.

The pattern information may include information about sample points extracted (or sampled) from the pattern of the garment. For example, when the pattern of the garment includes the first pattern and the second pattern, the pattern information of the first pattern may include information about sample points extracted from the first pattern and the pattern information of the second pattern may include information about sample points extracted from the second pattern.

The pattern may be a 2D object, and one or more one-dimensional (1D) sample points may be extracted from a 2D space corresponding to the pattern. For example, a predetermined number of sample points may be extracted from an outline (or an edge) of the pattern. For example, points (e.g., vertices, segment points, notches, etc.) those are determined to be important for clothing implementation in the pattern may be extracted as the sample points.

The clothing simulation method according to an embodiment may include extracting a predetermined number of sample points from each pattern of the garment and based on a position of a predetermined type of a point included in each pattern, adjusting positions of the sample points. For example, a predetermined number of sample points may be extracted from a reference point (e.g., a vertex located at the leftmost and uppermost part of the pattern) from an outline of the pattern, at a predetermined interval. When the total length of the outline of the pattern is N and the number of sample points to be extracted is “30”, sample points may be extracted at N/30 intervals along the outline from the reference point. The reference point may also be extracted as a sample point. When there is a predetermined type of points (e.g., vertices, segment points, notches, etc.) around the sample points, the position of the sample points may be adjusted to the position of the corresponding points.

An embodiment, according to 110, may include obtaining information about sample points of a target pattern, based on the length of an outline from a reference point of the target pattern among the patterns of the garment to each sample point extracted from the target pattern. The target pattern may refer to any one pattern among the patterns of the garment.

According to an embodiment, the information about the sample points may include at least one of information indicating positions of the sample points within the pattern, information indicating positions of the sample points within the garment, information indicating a positional relationship between sample points adjacent to each other, and information indicating a type of the sample points. A specific example of the information about the sample points is described in detail below.

According to an embodiment, the information about the sample points may include information indicating the positions of the sample points within the pattern. For example, information indicating a position of a sample point within the pattern may be determined based on the length of an outline from a reference point of the pattern to the sample point. The length of the outline from the reference point to the sample point may include the length of the outline extending from the reference point to the sample point in a predetermined direction (e.g., clockwise direction or counterclockwise direction). In other words, operation 110 may include obtaining the information about the sample points of the target pattern, based on the length of the outline from the reference point of the target pattern among the patterns of the garment to each sample point extracted from the target pattern. The target pattern may refer to any one pattern among the patterns of the garment. The information indicating the positions of the sample points within the pattern is described in detail below.

The automatic arrangement device may predict 120 sewing information about patterns of a garment based on embedding vector for each of patterns. The each of patterns is obtained by applying pattern information to pattern embedding model trained to estimate correlation between input pattern information.

The sewing information is information indicating a sewing relationship between patterns for making a garment and may include, for example, a pair of lines (sewing lines) that is sewn together within patterns of the garment. For example, in order to make a garment, when a first line, which is a part of an outline of the first pattern, and a second line, which is a part of an outline of the second pattern, are sewn together, the sewing information may include a pair of the first line and the second line. For example, the pair of lines sewn together may include information indicating both end points (e.g., both end points including a starting point and an end point) of each line. The sewing information may include information indicating the sewing direction of the lines sewn together. The sewing information is described in detail below.

A neural network model, according to embodiments, may include a pattern embedding model. The pattern embedding model may be a training model for outputting an embedding vector for each pattern from input pattern information for each pattern. For example, the pattern embedding model may include a transformer encoder trained to estimate a correlation between input data. The embedding vector for each pattern may be data generated based on a correlation between patterns estimated from pattern information input from the pattern embedding model.

An embodiment, according to 120, may include predicting the sewing information. The sewing information may include information about indicating a sewing line of a pattern pair, by applying, to a transformer decoder, an embedding vector pair corresponding to the pattern pair extracted from the patterns. The embedding vector pair corresponding to the pattern pair may include embedding vectors of the patterns included in the pattern pair. For example, when the pattern pair includes the first pattern and the second pattern, the embedding vector pair corresponding to the pattern pair may include an embedding vector of the first pattern and an embedding vector of the second pattern.

The information indicating the sewing line of the pattern pair may be output from the transformer decoder. The information indicating the sewing line may include a sample point of the pattern. The sewing line of the pattern pair may correspond to lines that are sewn together between the pattern pairs. The sewing line of the pattern pair may be specified by a sample point included in the pattern pair. For example, the information indicating the sewing line of the pattern pair may include information about sample points that are extracted from the first pattern of the pattern pair and correspond to a starting point and an end point of the sewing line included in the first pattern and information about sample points that are extracted from the second pattern of the pattern pair correspond to a starting point and an end point of the sewing line included in the second pattern. The sewing line and the sewing information are described in detail below.

An embedding vector pair corresponding to each of two pattern combinations that may be extracted from the patterns may be input to the transformer decoder. There may also be a pattern pair in which there are no lines that are sewn together. For example, in the garment, when the first pattern is sewn only with the second pattern, there are no sewing lines in pairs of patterns other than the first pattern and the second pattern. Based on reliability of the information indicating the sewing line of the pattern pair output from the transformer decoder, the presence of the sewing line in the pattern pair may be determined. For example, when the reliability of information indicating a sewing line output from a pair of the first pattern and the second pattern is greater than or equal to a threshold value, it may be determined that there is a sewing line between the first pattern and the second pattern. For example, when the reliability of information indicating a sewing line output from a pair of the first pattern and a third pattern is greater than or equal to a threshold value, it may be determined that there is no sewing line between the first pattern and the third pattern.

An embodiment, according to 120, may include applying pattern information of the first pattern to a first transformer encoder to obtain encoding data of the first pattern including an embedding vector for each sample point corresponding to the first pattern, applying pattern information of the second pattern to the first transformer encoder to obtain encoding data of the second pattern including an embedding vector for each sample point corresponding to the second pattern, applying the encoding data of the first pattern and the encoding data of the second pattern to a second transformer encoder to obtain an embedding vector of the first pattern and an embedding vector of the second pattern, and applying the embedding vector of the first pattern and the embedding vector of the second pattern to a transformer decoder to predict sewing information of the first pattern and the second pattern pair. The training and inference operations of a model including the first transformer encoder, the second transformer encoder, and the transformer decoder are described in detail below.

The automatic arrangement device may generate 130 simulation result of a garment based on sewing information. The simulation result may include 3D shape data of a garment produced by sewing the patterns based on the sewing information. The simulation result may be provided in the form of projections on a 2D screen through an output device such as a display.

The clothing simulation method according to an embodiment may include predicting arrangement information to generate a clothing simulation result.

For example, an embodiment may include predicting 120 arrangement information and sewing information of the patterns, based on an embedding vector for each of the patterns. In addition, an embodiment may include generating 130 the simulation result of the garment based on the sewing information and the arrangement information. The operation of predicting the sewing information and the arrangement information is described in detail below.

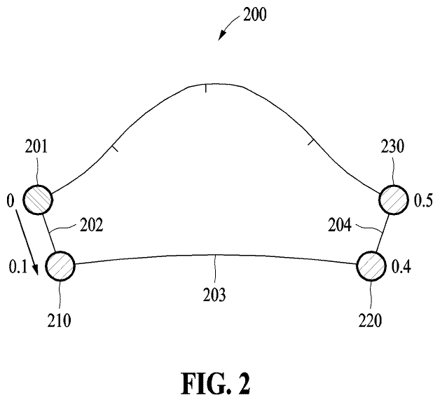

FIG. 2 is a diagram illustrating sample points of a pattern and information indicating positions of the sample points within the pattern, according to an embodiment.

Referring to FIG. 2, sample points extracted from a pattern 200 may include a first sample point 210, a second sample point 220, and a third sample point 230.

As described above, information indicating positions of the sample points within the pattern 200 may be determined based on the length of an outline from a reference point 201, which is the leftmost and uppermost vertex of the pattern 200, to the sample points. For example, the information indicating the positions of the sample points within the pattern 200 may be determined based on a parameter (hereinafter referred to as a length parameter) having a ratio value of the length of an outline extending in the counterclockwise (or clockwise) direction from the reference point 201 to the sample points compared to the length of the entire outline of the pattern 200.

For example, the length of the outline extending in the counterclockwise direction from the reference point 201 to the first sample point 210 may correspond to the length of a first line 202. When the length of the first line 202 is 0.1 of the length of the entire outline of the pattern 200, the length parameter of the first sample point 210 may be determined to be 0.1.

For example, the length of the outline extending in the counterclockwise direction from the reference point 201 to the second sample point 220 may correspond to the sum of the lengths of the first line 202 and a second line 203. When the sum of the lengths of the first line 202 and the second line 203 is 0.4 of the length of the entire outline of the pattern 200, the length parameter of the second sample point 220 may be determined to be 0.4.

For example, the length of the outline extending in the counterclockwise direction from the reference point 201 to the third sample point 230 may correspond to the sum of the lengths of the first line 202, the second line 203, and a third line 204. When the sum of the lengths of the first line 202, the second line 203, and the third line 204 is 0.5 of the length of the entire outline of the pattern 200, the length parameter of the third sample point 230 may be determined to be 0.5.

For example, the reference point 201 may also be a sample point of the pattern 200. For the reference point 201, the length parameter may be determined to be 0.

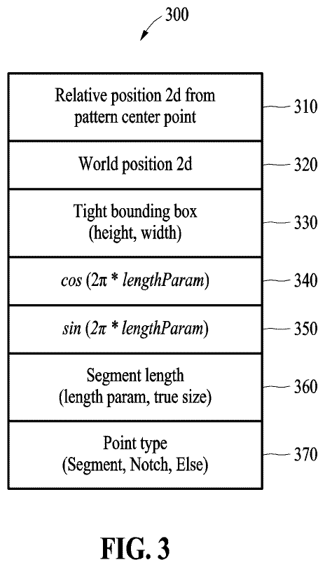

FIG. 3 is a diagram illustrating sample point information according to an embodiment.

Referring to FIG. 3, sample point information 300 may be information about any one point extracted from a pattern. Information about sample points extracted from a pattern described above may correspond to a set of the sample point information 300 corresponding to each sample point extracted from the pattern. In other words, pattern information may include the set of the sample point information 300 corresponding to each sample point extracted from the pattern. For example, when a first sample point and a second sample point are extracted from a first pattern, the pattern information of the first pattern may include the sample point information 300 corresponding to the first sample point and the sample point information 300 corresponding to the second sample point.

The sample point information 300 may include relative position information 310 of a sample point from the center point of the pattern. The relative position information 310 of the sample point from the center point of the pattern may correspond to information indicating a position of the sample point within the pattern. For example, the relative position information 310 of the sample point from the center point of the pattern may be 2D coordinate data based on the center point of the pattern.

The sample point information 300 may include world coordinate (e.g., world position) information 320 of the sample point. The world coordinate information 320 of the sample point may correspond to the information indicating a position of the sample point within a garment.

The sample point information 300 may include bounding box information 330. The bounding box information 330 is information about the size of the pattern and may include height and width values of a rectangle including the pattern.

The sample point information 300 may include cosine transformation information 340 of a length parameter (e.g., lengthParam) and sine transformation information 350 of the length parameter. The length parameter may correspond to the length parameter described above with reference to FIG. 2.

The sample point information 300 may include segment length information 360.

The sample point information 300 may include sample point type information 370. The type of the sample point may include, for example, segment types, notch types, and vertex types.

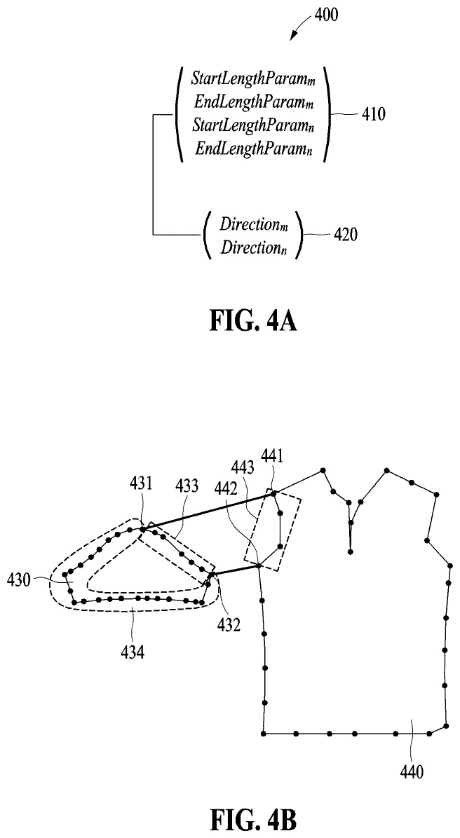

FIGS. 4A and 4B are diagrams illustrating sewing information and automatically matched sewing parts, according to an embodiment.

Referring to FIG. 4A, an example of sewing information 400 of a pattern pair including pattern m and pattern n according to an embodiment is shown.

The sewing information 400 may include information 410 for indicating sewing lines of the pattern pair. The information 410 for indicating the sewing lines of the pattern pair may include a length parameter (e.g., StartLengthParamₘ) of a starting point of a sewing line included in pattern m, a length parameter (e.g., EndLengthParamₘ) of an end point of the sewing line included in pattern m, a length parameter (e.g., StartLengthParamₙ) of a starting point of a sewing line included in pattern n, and a length parameter (e.g., EndLengthParamₙ) of an end point of the sewing line included in pattern n.

The sewing information 400 may include information 420 for indicating a sewing direction of the sewing lines. The information 420 for indicating the sewing direction of the sewing lines may include information (e.g., Directionₘ) for indicating a sewing direction of the sewing line included in pattern m and information (e.g., Directionₙ) for indicating a sewing direction of the sewing line included in pattern n. The sewing direction is a direction connecting the starting point and the end point of the sewing line along an outline and may be determined as, for example, a clockwise direction or a counterclockwise direction.

For example, referring to FIG. 4B, when the information indicating the sewing direction of the sewing line included in a pattern m 430 indicates the clockwise direction, a line 433 determined by connecting an outline in the clockwise direction from a starting point 431 to an end point 432 of the sewing line included in the pattern m 430 may correspond to the sewing line included in the pattern m 430. When the information indicating the sewing direction of the sewing line included in the pattern m 430 indicates the counterclockwise direction, a line 434 determined by connecting an outline in the counterclockwise direction from a starting point 431 to an end point 432 of the sewing line included in the pattern m 430 may correspond to the sewing line included in the pattern m 430.

For example, when the information indicating the sewing direction of the sewing line included in a pattern n 440 indicates the counterclockwise direction, a line 443 determined by connecting an outline in the counterclockwise direction from a starting point 441 to an end point 442 of the sewing line included in the pattern n 440 may correspond to the sewing line included in the pattern n 440.

In order to make a garment, the pattern m 430 and the pattern n 440 may be sewn together along the sewing line so that the starting point 431 of the sewing line included in the pattern m 430 and the starting point 441 of the sewing line included in the pattern n 440 are sewn together and the end point 432 of the sewing line included in the pattern m 430 and the end point 442 of the sewing line included in the pattern n 440 are sewn together.

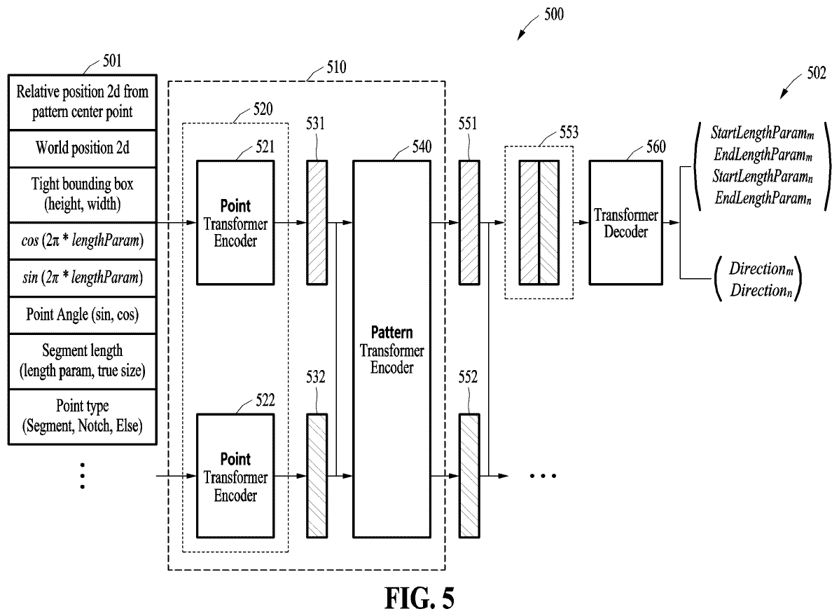

FIG. 5 is a block diagram illustrating a structure of a n neural network model for a clothing simulation of predicting sewing information, according to an embodiment. Hereinafter, the neural network model for the clothing simulation may be referred to as a clothing simulation model.

A clothing simulation model 500 may be a neural network model for predicting or outputting data for generating a clothing simulation result from pattern information for each pattern of a garment. For example, the data for generating the clothing simulation result may include sewing information 502.

Referring to FIG. 5, the clothing simulation model 500 may include a pattern embedding model 510. As described above, the pattern embedding model 510 may be a training model for outputting an embedding vector for each pattern from input pattern information for each pattern.

The pattern embedding model 510 may include a point transformer encoder 520 trained to estimate a correlation between sample points extracted from the same pattern from the input pattern information and a pattern transformer encoder 540 trained to estimate a correlation between patterns from encoding data 531 and 532 for each pattern obtained from embedding vectors of the sample points output from the point transformer encoder 520. The point transformer encoder 520 may correspond to the first transformer encoder described above. The pattern transformer encoder 540 may correspond to the second transformer encoder described above.

The point transformer encoder 520 may include a neural network trained to estimate the correlation between the sample points extracted from the pattern, based on information about the sample points included in the pattern information of the pattern. The point transformer encoder 520 may estimate the correlation between the sample points from the information about the sample points included in the input pattern information and may output embedding vectors corresponding to each of the sample points. The information about the sample points of the pattern may include sample point information 501 corresponding to each sample point extracted from the corresponding pattern.

The encoding data 531 and 532 of the pattern may be obtained from the embedding vectors for each sample point extracted from the same pattern output from the point transformer encoder 520. For example, the encoding data 531 and 532 of the pattern may be data generated by connecting or adding the embedding vectors corresponding to the sample points extracted from the corresponding pattern.

For example, the sample point information 501 corresponding to each of the sample points extracted from a first pattern may be input to a first point transformer encoder 521. The embedding vector corresponding to each of the sample points extracted from the first pattern may be obtained from the first point transformer encoder 521, and the encoding data 531 of the first pattern may be obtained from the embedding vector.

For example, the sample point information 501 corresponding to each of the sample points extracted from a second pattern may be input to a second point transformer encoder 522. The embedding vector corresponding to each of the sample points extracted from the second pattern may be obtained from the second point transformer encoder 522 and the encoding data 532 of the second pattern may be obtained from the embedding vector.

In FIG. 5, the first point transformer encoder 521 and the second point transformer encoder 522 that process the pattern information of each pattern are shown in separate configurations. However, this illustrates a logical structure of the point transformer 520, in which operations are performed in units of the pattern information of each pattern by the point transformer 520, and includes hardware configurations of the point transformer 520 by as many as the number of patterns. However, the physical structure of the point transformer 520 is not limited thereto. For example, the pattern information for each pattern may be sequentially input to the point transformer 520 and the encoding data 531 and 532 for each pattern may be obtained through a serial operation. For example, the pattern information of all patterns input to the point transformer 520 may be processed in parallel in units of the pattern information for each pattern to obtain the encoding data 531 and 532 for each pattern.

The pattern transformer encoder 540 may include a neural network trained to estimate the correlation between the patterns, based on the encoding data 531 and 532 for each pattern. The pattern transformer encoder 540 may estimate the correlation between the patterns from the encoding data 531 and 532 for each input pattern and may output embedding vectors 551 and 552 corresponding to each pattern.

A transformer decoder 560 may include a neural network trained to estimate a sewing line of a pattern pair from an embedding vector pair 553 of an input pattern pair. The transformer decoder 560 may output the sewing information 502 of the pattern pair from the embedding vector pair 553 of the input pattern pair. For example, the sewing information 502 output from the transformer decoder 560 may correspond to the sewing information 400 of FIG. 4A.

Embedding vector pairs of all pattern pairs that may be combined from the patterns of the garment may be input to the transformer decoder 560. For example, when the garment includes “n” patterns, “ₙC₂” different embedding vector pairs corresponding to “ₙC₂” different pattern pairs may be input to the transformer decoder 560, respectively. As described above, there may be pattern pairs in which there are no lines sewn together. When an embedding vector pair of a pattern pair in which there are no lines sewn together is input to the transformer decoder 560, information indicating that there is no sewing line may be output. Alternatively, the sewing information 502 may be output together with a reliability score and the sewing information 502 may be filtered by a post-processing operation on the output of the transformer decoder 560. For example, the sewing information 502 in which the reliability score is less than a threshold value may be determined not to be a sewing line and may be excluded from the sewing information 502.

The clothing simulation model 500 according to an embodiment may be trained based on ground truth about the sewing information 502. The clothing simulation model 500 may be trained based on a loss about the difference between the predicted sewing information 502 and the ground truth. The clothing simulation model 500 may be trained to reduce the loss about the difference between the predicted sewing information 502 and the ground truth.

For example, the loss about the difference between the predicted sewing information 502 and the ground truth may include a loss about the difference between information indicating a predicted sewing line and the ground truth. The information indicating a sewing line may include sample point information corresponding to a starting point of the sewing line included in the pattern and sample point information corresponding to an end point. For example, the information indicating the sewing line may include at least one of length parameters of the starting point and the end point of the sewing line included in the pattern and world coordinates of the starting point and the end point of the sewing line included in the pattern.

For example, the loss about the difference between the predicted sewing information 502 and the ground truth may include a loss about the difference between information indicating a sewing direction and the ground truth.

For example, the loss about the difference between the predicted sewing information 502 and the ground truth may include a loss about the difference between the ground truth and the shape of the sewing line generated as a simulation result based on the predicted sewing information 502. For example, a loss may be included, which is defined to have a smaller value as intersection over union (IoU) increases, wherein the IoU indicates a degree of overlapping between the shape of the sewing line generated as the simulation result based on the predicted sewing information 502 and the shape of the sewing line included in a ground truth simulation result.

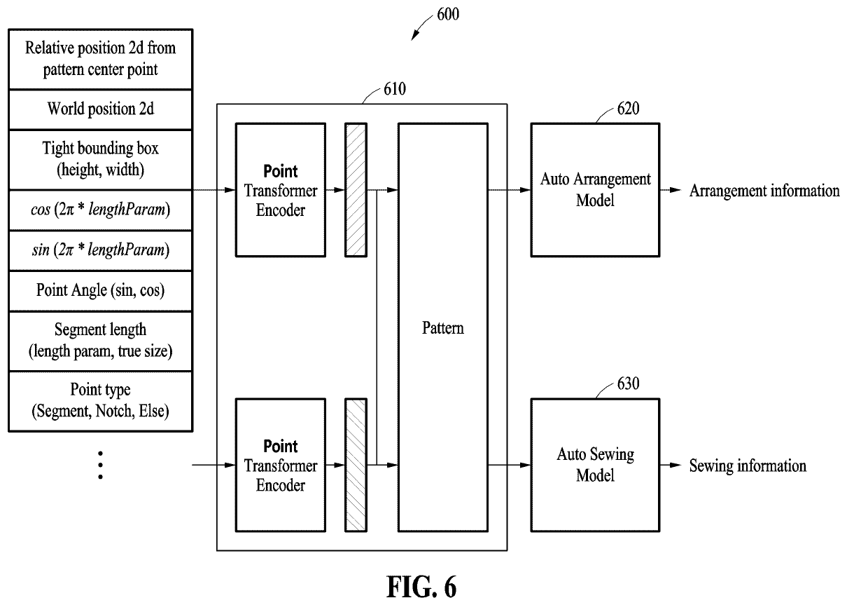

FIG. 6 is a block diagram illustrating a structure of a neural network model for predicting sewing information and arrangement information, according to an embodiment.

Referring to FIG. 6, a clothing simulation model 600 may include a neural network model for predicting sewing information and arrangement information. For example, data for generating a clothing simulation result may include not only the sewing information but also the arrangement information.

The clothing simulation model 600 according to an embodiment may include a pattern embedding model 610, an automatic arrangement model 620, and an automatic sewing model 630. The pattern embedding model 610 may correspond to the pattern embedding model 510 of FIG. 5.

The automatic sewing model 630 may be a model for predicting the sewing information of patterns of a garment, based on an embedding vector for each pattern output from the pattern embedding model 610. For example, the automatic sewing model 630 may include the transformer decoder 560 described above with reference to FIG. 5.

The automatic arrangement model 620 may be a model for predicting the arrangement information of the patterns, based on the embedding vector for each pattern output from the pattern embedding model 610.

Here, the arrangement information may refer to point(s) at which 2D patterns are arranged on an object on which a 3D virtual garment may be worn. For example, the arrangement information may include information about an arrangement plate or an arrangement point preset on the object on which the 3D virtual garment may be worn. In addition, the arrangement information may further include information about patterns being arranged at an arrangement point, which is one or a plurality of points on the arrangement plate on the object on which the 3D virtual garment may be worn.

The object may include a 3D object. Specifically, the object may be an object on which the 3D virtual garment may be worn and may correspond to a 3D avatar. In addition, the object may be an object on which the 3D virtual garment may be worn and may include a hanger, a human body model, a mannequin, and furniture.

An arrangement point described herein refers to an initial position of an associated piece relative to a body part of a 3D avatar before the associated piece is connected to one or more adjacent piece via a seamline. For simulation or visual representation, a garment may be assembled by moving its pieces from their arrangement points to assembled points while interacting with the 3D avatar. In an embodiment of a 3D avatar, there are 109 arrangement points.

The arrangement information may include at least one of a name of the arrangement point and a 3D position of the arrangement point. The clothing simulation model 600 may output arrangement point information in the form of, for example, 3D position coordinates of the arrangement point, an offset, and/or the name of the arrangement point. However, the arrangement point information output from the clothing simulation model 600 is not necessarily limited thereto. Here, the offset may correspond to a value indicating how much the arrangement point has moved in x, y, and z axes with respect to a specific point on 3D position coordinates.

Based on the arrangement information output from the automatic arrangement model 630, the patterns of the garment may be arranged on the object.

Through the automatic arrangement model 630, initial arrangement positions of 2D pattern(s) within the object may be determined according to the arrangement information about predicting on which part of the object the 2D pattern(s) need to be arranged. The simulation result may include the 3D shape of the garment, in which the 2D pattern(s) are arranged at specific positions on the object according to the arrangement information and the garment is sewn together to be worn according to the sewing information.

The clothing simulation model 600 according to an embodiment may be trained based on ground truth about the arrangement information. The clothing simulation model 600 may be trained based on a loss about the difference between the predicted arrangement information and the ground truth. Various training algorithms, including supervised training algorithms, may be used for training based on the output data and the ground truth of the clothing simulation model 600.

The embedding vector for each pattern output from the pattern embedding model 610 according to an embodiment may be used to predict both the sewing information and the arrangement information. The pattern embedding model 610 may be trained based on a loss about the difference between the predicted sewing information and the ground truth and a loss about the difference between the predicted arrangement information and the ground truth.

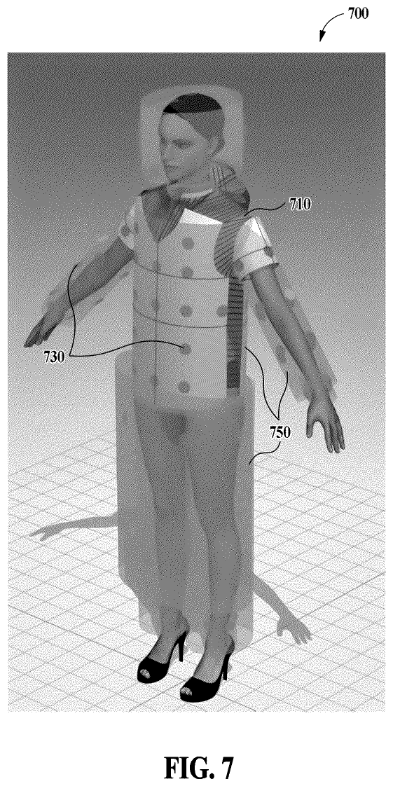

FIG. 7 is a diagram illustrating arrangement points and associated arrangement plates, according to an embodiment.

FIG. 7 is a diagram illustrating arrangement points 730 and associated arrangement plates 750, according to an embodiment. There may be, for example, 730 arrangement points associated with a 3D avatar 710. The arrangement points 730 are points at which 2D patterns are to be arranged on or above body parts of the 3D avatar 710. The 2D patterns are arranged at the arrangement points and then assembled onto or donned on the 3D avatar 710 for clothing simulation.

The names of the arrangement points 730 may correspond to classification names of the arrangement plates 750 to which the arrangement points 730 are assigned. For example, the names of the arrangement points 730 may be major classification names obtained through a broad classification of the arrangement plates 750 including the arrangement points 730, or may be minor classification names obtained through a detailed classification of the arrangement plates 750 having the major classification names.

An arrangement plate includes one or more arrangement points corresponding to each body part reflected with the body shape and the posture of the 3D avatar 710. Arrangement plates 750 may correspond to body parts of the 3D avatar 710. Each of body part arrangement plates may be assigned to both hands, both feet, both elbows, both knees, both arms, both wrists, left and right bodies, and the like. For example, a body part arrangement plate may be formed in the shape of a 3D column that surrounds a corresponding body part. The 3D column may be shaped as, for example, a cylinder, an elliptical cylinder, and a polygonal prism. The body part arrangement plate may be formed shapes other than a 3D column.

The arrangement plates 750 may be classified through a broad classification into a body arrangement plate, an arm arrangement plate, a wrist arrangement plate, a shoulder arrangement plate, a leg arrangement plate, an ankle arrangement plate, a lower body arrangement plate, a neck arrangement plate, and a head arrangement plate. The body arrangement plate may include two sub-arrangement plates: a left body arrangement plate and a right body arrangement plate, or a front body arrangement plate and a back body arrangement plate. The arm arrangement plate may include sub-arrangement plates for a left arm, a right arm, and both arms. The wrist arrangement plate may include sub-arrangement plates for a left wrist, a right wrist, and both wrists. The shoulder arrangement plate may include sub-arrangement plates for a left shoulder, a right shoulder, and both shoulders. The leg arrangement plate may include sub-arrangement plates for a left leg, a right leg, and both legs, or front legs and back legs. The ankle arrangement plate may include sub-arrangement plates for a left ankle, a right ankle, and both ankles. The lower body arrangement plate may include sub-arrangement plates for a left lower body and a right lower body, or a front lower body and a back lower body. The neck arrangement plate may include sub-arrangement plates for a left neck portion, a right neck portion, and both neck portions. The head arrangement plate may include sub-arrangement plates divided in three directions of the head, for example, left, right, and vertical directions, or X (horizontal), Y (vertical), and Z (depth) directions.

The name of the arrangement point(s) 730 may correspond to the classification name of the arrangement plate(s) 750 to which the arrangement point(s) 730 belongs based on the arrangement plate(s) 750. For example, the name of the arrangement point(s) 730 may be a general category name of the arrangement board including the arrangement point(s) 730, or may be a classification name of a detailed arrangement board belonging to the main category of the arrangement board.

The placement plate(s) 750 may refer to a plate(s) including placement points corresponding to each body part reflecting the body shape and posture of the 3D avatar 710. The placement plate(s) 750 are placement plate(s) corresponding to each body part of the three-dimensional avatar, such as both hands, both feet, both elbows, both knees, both arms, both wrists, left and right torso, etc.) (“Arrangement board for each body part”). For example, the arrangement plate for each body part may be configured in the form of a three-dimensional pillar surrounding the corresponding body part. Three-dimensional pillars may include, for example, cylinders, elliptical pillars, polygonal pillars, etc. The placement board for each body part may be composed of various shapes other than three-dimensional columns, but is not necessarily limited thereto.

The placement plate(s) 750 are, for example, a body placement plate, an arm placement plate, a wrist placement plate, a shoulder placement plate, a leg placement plate, and an ankle (It may be divided into major categories such as Ankle Placement Plate, Lower Body Placement Plate, Neck Placement Plate, and Head Placement Plate, but is not necessarily limited thereto.

The torso arrangement plate may be composed of two detailed arrangement plates, for example, a left torso arrangement plate and a right torso arrangement plate, or a front torso arrangement plate and a rear torso arrangement plate. For example, the arm arrangement board may be composed of detailed arrangement boards for both left and right arms. For example, the wrist placement board may be composed of detailed placement boards for both the left and right wrists. For example, the shoulder arrangement plate may be composed of detailed arrangement plates for both left and right shoulders. For example, the leg arrangement board may be composed of both left and right legs, or front and rear leg detail arrangement boards.

For example, the automatic arrangement model (the automatic arrangement model 620 of FIG. 6) may output the arrangement information indicating that the target pattern corresponds to any one of the arrangement points 730. Based on the arrangement information, the target pattern may be arranged on the 3D avatar 710 so that the avatar 710 is arranged at the arrangement point corresponding to a specific position (e.g., the center point) of the target pattern. Alternatively, the target pattern may be arranged on the 3D avatar 710 so that the avatar 710 is arranged at the center of the arrangement plate where the arrangement point corresponding to a specific position (e.g., the center point) is arranged.

For example, the automatic arrangement model (the automatic arrangement model 620 of FIG. 6) may output the arrangement information indicating that the target pattern corresponds to one arrangement plate, such as the front body (e.g., Body_Front) or the back body (e.g., Body_Back). The target pattern may be arranged at the center position of the corresponding arrangement plate, based on the arrangement information.

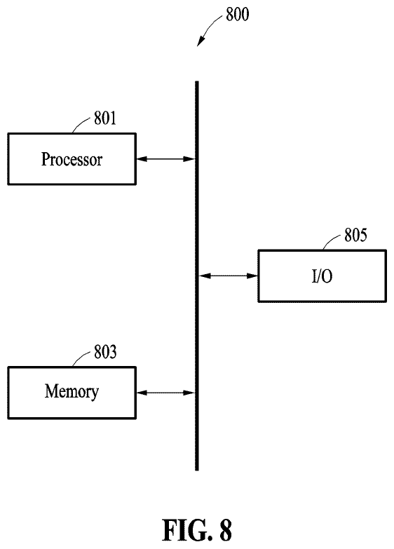

FIG. 8 is a block diagram illustrating an automatic arrangement device, according to an embodiment.

Referring to FIG. 8, a clothing simulation apparatus (e.g., an automatic arrangement device) 800 according to an embodiment may include a processor 801, a memory 803, and an input/output (I/O) device 805. The clothing simulation apparatus 800 may include an apparatus for performing the clothing simulation method described above with reference to FIGS. 1 to 7. Hereinafter, the clothing simulation apparatus 800 may be simply referred to as an apparatus. A communication interface, the processor 801, the memory 803, and the I/O device 805 may be connected to each other via a communication bus. The communication interface may obtain pattern information for each of patterns of a garment, including information about sample points extracted from the each of patterns.

The processor 801 may perform at least one operation of the clothing simulation method described above with reference to FIGS. 1 to 7. For example, the processor 801 may perform at least one of obtaining pattern information for each pattern including information about sample points extracted from each pattern of a garment, based on an embedding vector for each pattern obtained by applying the pattern information for each pattern to a pattern embedding model trained to estimate a correlation between input pattern information, predicting sewing information about patterns of the garment, and based on the sewing information, generating a simulation result of the garment.

The memory 803 according to an embodiment may be a volatile or non-volatile memory and may store data related to the clothing simulation method described above with reference to FIGS. 1 to 7. For example, the memory 803 may store data generated during the process of performing the clothing simulation method or data necessary for performing the clothing simulation method. For example, the memory 803 may store the pattern information for each pattern. For example, the memory 803 may store a weight of at least one layer of a neural network included in the clothing simulation model.

The apparatus 800 may exchange data with a user or an external device (e.g., a personal computer or a network) through the I/O device 805. For example, the apparatus 800 may receive the pattern information for each pattern through the I/O device 805 and may output the simulation result of the garment.

According to an embodiment, the memory 803 may store a program configured to implement the clothing simulation method described above with reference to FIGS. 1 to 7. The processor 801 may execute a program stored in the memory 803 and may control the apparatus 800. Code of the program executed by the processor 801 may be stored in the memory 803.

The apparatus 800 may further include other components not shown in the drawings. For example, the apparatus 800 may include a communication module that provides a function for the apparatus 800 to communicate with another electronic device or another server via a network. An entirety or a portion of the clothing simulation model may be stored in an external memory. The apparatus 800 may obtain the sewing information and/or the arrangement information about the patterns of the garment by communicating with the clothing simulation model stored in the external memory through the communication module. In addition, for example, the apparatus 800 may further include other components such as a transceiver, various sensors, and a database.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specifically designed and constructed for the purposes of examples, or they may be of the kind well known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A clothing simulation method, comprising:
obtaining pattern information for each of patterns of a garment, the pattern information including information about sample points extracted from each of the patterns;
predicting sewing information about the patterns based on an embedding vector for each of the patterns obtained by applying the pattern information to a pattern embedding model trained to estimate a correlation between input pattern information; and
based on the sewing information, generating a simulation result of the garment.

2. The clothing simulation method of claim 1, further comprising:
extracting a predetermined number of sample points from each of the patterns of the garment; and
based on a position of a predetermined type of a point included in each of the patterns, adjusting positions of the sample points.

3. The clothing simulation method of claim 1, wherein the obtaining of the pattern information for each of the patterns comprises obtaining information about sample points of a target pattern, based on a length of an outline from a reference point of the target pattern among the patterns of the garment to each sample point extracted from the target pattern.

4. The clothing simulation method of claim 1, wherein:
the pattern embedding model comprises a transformer encoder, and
the predicting of the sewing information comprises obtaining information indicating a sewing line of a pattern pair extracted from the patterns by applying, to a transformer decoder, an embedding vector pair corresponding to the pattern pair.

5. The clothing simulation method of claim 1, wherein the pattern embedding model comprises:
a first transformer encoder trained to estimate a correlation between sample points extracted from a same pattern from the input pattern information; and
a second transformer encoder trained to estimate a correlation between patterns from encoding data for each of the patterns obtained from embedding vectors of sample points output from the first transformer encoder.

6. The clothing simulation method of claim 5, wherein the predicting of the sewing information comprises:
obtaining encoding data of a first pattern including an embedding vector for each sample point corresponding to the first pattern by applying pattern information of the first pattern to the first transformer encoder;
obtaining encoding data of a second pattern including an embedding vector for each sample point corresponding to the second pattern by applying pattern information of the second pattern to the first transformer encoder;
obtaining an embedding vector of the first pattern and an embedding vector of the second pattern by applying the encoding data of the first pattern and the encoding data of the second pattern to the second transformer encoder; and
predicting sewing information about a pattern pair of the first pattern and the second pattern by applying the embedding vector of the first pattern and the embedding vector of the second pattern to a transformer decoder.

7. The clothing simulation method of claim 1, wherein the sewing information comprises a pair of lines sewn together within the patterns.

8. The clothing simulation method of claim 7, wherein the sewing information further includes information indicating a sewing direction of the lines.

9. The clothing simulation method of claim 4, wherein the information indicating the sewing line of the pattern pair comprises:
information about sample points that are extracted from a first pattern of the pattern pair and correspond to a starting point and an end point of the sewing line included in the first pattern; and
information about sample points that are extracted from a second pattern of the pattern pair and correspond to a starting point and an end point of the sewing line included in the second pattern.

10. The clothing simulation method of claim 1, wherein the pattern embedding model is trained based on a loss about a difference between the predicted sewing information and ground truth.

11. The clothing simulation method of claim 1, wherein:
the predicting of the sewing information about the patterns comprises predicting arrangement information about the patterns and the sewing information, based on an embedding vector for each of the patterns, and
the generating of the simulation result of the garment comprises generating the simulation result of the garment, based on the sewing information and the arrangement information.

12. The clothing simulation method of claim 11, wherein the pattern embedding model is trained based on a loss about a difference between the predicted sewing information and ground truth, and a loss about a difference between the predicted arrangement information and ground truth.

13. The clothing simulation method of claim 1, wherein the information about the sample points comprises at least one of:
information indicating positions of the sample points within a pattern of the garment;
information indicating positions of the sample points within the garment;
information indicating a positional relationship between adjacent ones of the sample points; and
information indicating a type of the sample points.

14. A non-transitory computer-readable storage medium storing instructions that, the instructions when executed by one or more processors, cause the one or more processors to:
obtain pattern information for each of patterns of a garment, the pattern information including information about sample points extracted from each of the patterns;
predict sewing information about the patterns based on an embedding vector for each of the patterns obtained by applying the pattern information to a pattern embedding model trained to estimate a correlation between input pattern information; and
based on the sewing information, generate a simulation result of the garment.

15. A clothing simulation apparatus comprising:
one or more processors; and
memory storing instructions thereon, the instructions when executed by the one or more processors cause the one or more processors to:
obtain pattern information for each of patterns of a garment, the pattern information including information about sample points extracted from each of the patterns;
predict sewing information about the patterns based on an embedding vector for each of the patterns obtained by applying the pattern information to a pattern embedding model trained to estimate a correlation between input pattern information; and
based on the sewing information, generate a simulation result of the garment.
